(19) United States
(12) Patent Application Publication
(10) Pub. No.: US 2012/0330607 A1
(43) Pub. Date: Dec. 27, 2012

(54) DIGITAL READOUT MEASUREMENT DEVICE

(75) Inventor: Jerry MATHIS, San Marcos, CA (US)

(73) Assignee: PI TAPE CORPORATION, Escondido, CA (US)

(21) Appl. No.: 13/168,852

(22) Filed: Jun. 24, 2011

(51) Int. Cl. G01B 7/12

(52) U.S. Cl. 702/157

(57) ABSTRACT

A linear measurement device for digitally providing circumference and diameter readings of an object being measured. The tail end of a tape passes by a reader element in a digital unit which is equipped electronically with the pi formula to provide selective readings of diameter in English and metric units, as well as circumference readings. The device can be employed for external (outside) and internal (inside) measurements.

### FIELD OF INVENTION

This invention, as evidenced by the embodiments described and shown herein, relates generally to the linear tapes for conversion of length to circumference and diameter readings, and more particularly to such a tape with computation and display structure to provide digital readings of circumference and diameter of an object.

### BACKGROUND OF THE INVENTION

There are a myriad of uses for linear tapes which can be formed into a circle around the outside or the inside of a circular object to provide readings for circumference or diameter. A pi conversion can be incorporated into a vernier device with permanent markings on the end of the tape that cooperatively aligns with the vernier device to provide visual readings of diameter. Of course, length (circumference) markings can be read directly with the tape in place on or in the object being measured.

It is well known that vernier readings, however precise, are still approximations at the very point of precision. Not only is there some element of interpolation, the number or distance read depends on the eyesight and care of the user.

### SUMMARY OF EMBODIMENTS OF THE INVENTION

Embodiments of the present invention removes any imprecision that may result from user error and interpolation of the vernier apparatus by providing precise digital readings of circumference and diameter.

A tape is formed with a machine readable side commencing from near the tail end and extending over a significant length of the tape toward the head end. At the head end is a unit incorporating a reader by which the machine readable tail end passes as the tape is fitted to the surface (external or internal) of the object being measured.

The unit has electronics which convert the readings from the tape to circumference and diameter, in either metric or English units, and provides a precise visual digital reading of the desired measurement in the desired units.

The head end of the device is formed with an opening through which the tail end of the tape passes as it slides along the unit and the distances on the machine readable portion of the tape are converted to the readings desired.

### BRIEF DESCRIPTION OF THE DRAWING

The purposes, features, and advantages of the disclosed device will be more readily perceived from the following detailed description, when read in conjunction with the accompanying drawing, wherein:

FIG. 1 is the perspective view of a digital readout measurement device according to one embodiment of the invention;

FIG. 2 is an enlarged front view of a portion of the FIG. 1 embodiment;

FIG. 3 is an enlarged front view of a second embodiment;

FIG. 4 is a perspective view of the digital readout device of FIG. 1;

FIG. 5 is a schematic representation of the measurement device converter of FIG. 1; and

FIG. 6 is a flow chart of the method of use of the FIG. 1 embodiment.

### DETAILED DESCRIPTION OF EMBODIMENTS OF THE INVENTION

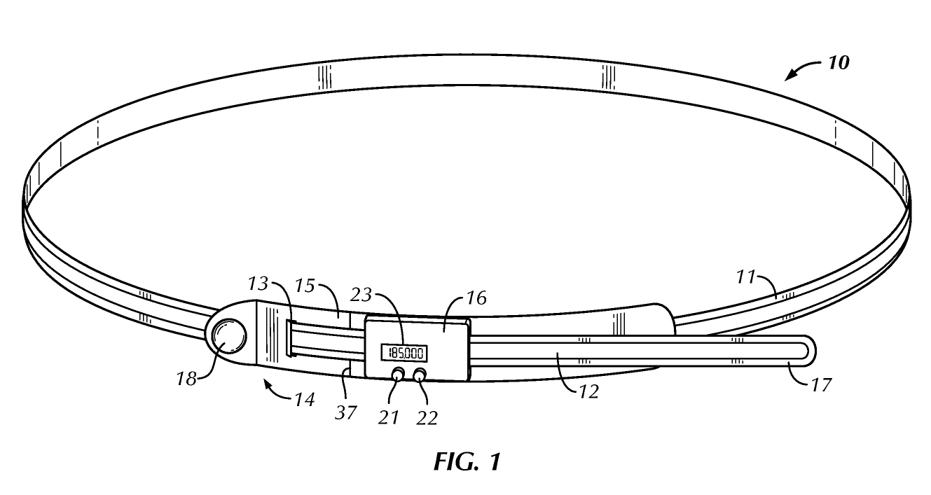

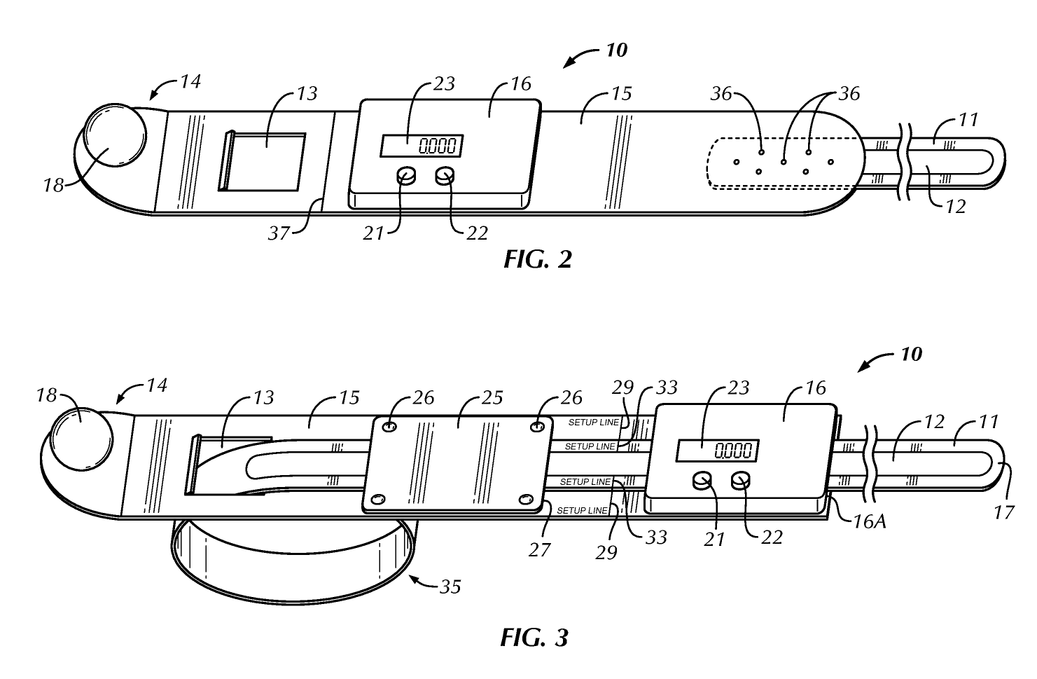

With reference now to the drawing, and more particularly to FIGS. 1 and 2 thereof, measurement device 10 includes elongated tape 11 having a machine readable surface 12. Surface 12 may be magnetic, optical, or any other machine readable material which is programmed in increments. Examples of the increment of spacing are 0.01 millimeter and 0.0005 inch. Of course finer or courser spacings may be employed. It is anticipated that tolerances will range from 0.13 millimeter and 0.005 inch for one level of precision, to high precision tolerances of 0.03 millimeter and 0.001 inch.

It should be understood that available electronic readers, whether magnetic, optical, or other types, have the ability to read leading and trailing edges of markings to achieve even higher precisions than what the recorded or programmed increments would directly supply.

Tape 11 includes mounting element or vernier plate 15 connected to one end, the head end, of the tape. Tail end 17 of the tape passes through opening 13 at the head end of the vernier plate. Handle or knob 18 may optionally be provided for the user's convenience in handling the measurement device.

Mounted to vernier plate 15 is digital device 16 which is preferably internally equipped with a computation means which includes the pi formula or pi conversion factor for converting lengths to diameters. Device 16 has a rearward facing conventional magnetic or optical reader element (not shown) coupled internally to relatively simple electronic circuitry in the digital device. Tail end 17 of tape 11 passes over vernier plate 15 and under the digital device so that readable surface 12 faces and passes by the reader element in device 16 at a conventional close distance to enable the surface increments to be sensed by the reader element. Alternatively, digital device 16 may be formed with a slot through which the tape passes, but with the same orientation of surface 12 passing by the reader element.

Devices which provide a digital readout of linear measurements can be obtained from Master-Carr Supply Company in Santa Fe Springs, Calif. An example in the Master-Carr Catalog 116 is the Mitutoyo Electronic Scales. A linear readout device of the type here identified, can be programmed as shown in FIG. 5. The direct reading of change of position of the tape is provided by sensor 41 and applied to converter 42. As will be described herein, a button is depressed to show a readout, selectively, of length in English or metric units, or diameter in English or metric units. Converter 42 is programmed with the pi formula or conversion data, to show the selected quantity. A person of ordinary skill in this field can easily provide such a converter with selector buttons.

When the measurement device described herein is to be employed to measure the circumference or the diameter of an object, tape 11 is applied loosely to the surface of the object, with tail 17 passing through opening 13 and behind digital device 16 so that the machine readable surface 12 is in reading position with respect to the rearward facing reader element in device 16. For initializing purposes, a setup line on the vernier plate is aligned with a setup line on the tape, as will be discussed in greater detail with respect to FIG. 3.

Digital device 16 is programmed to perform as now described. After setup has been accomplished, tape 11 is pulled to a desired tension (nominally five pounds for external measurements) so that the tape is snugly against the external surface of the object being measured. The reader element effectively counts the number of increments on tape surface 12 that pass by after initialization and converts that length change to selected readings in digital readout window 23.

To read the circumference and diameter of the object, left button 21 may be depressed a set amount of times. For example, the digital unit may be programmed so that a single depression of button 21 shows the circumference of the object in inches; two depressions may show the diameter of the object in inches; three depressions can show the circumference of the object in metric units; and four depressions of button 21 may show metric diameter of the object. Of course, unit 16 can be programmed to react to any number of depressions to obtain any one of the four possible visual outputs. The readings may be also, or optionally, connected or transmitted to an external device, such as a monitor screen or any other electronic or visual display device. Further, the outputs of the reader element may be connected or transmitted to an external computation means which incorporates the pi formula and provides the selected diameter and circumference readings.

At the conclusion of the reading sequence, the tape may be relaxed and right button 22 is held depressed until the readings in window 23 disappear.

With reference now to FIG. 3, the initial setup and operation of an alternative embodiment of the measurement device will be described. The initial setup and operation of the FIGS. 1 and 2 embodiments follows essentially the same procedure.

Vernier plate 15 is constructed with handle end 14 having knob 18, spaced from opening 13. Guide plate 25 is secured on the outside surface of plate 15 by any suitable means such as rivets 26. Stand offs, such as one or more washers, may be employed to provide gap 27 through which tape 11 can pass. The head end of tape 11 may be secured to vernier plate 15 by any suitable means.

Between guide plate 25 and digital device 16 appears “setup line” 29, scribed or etched on the outer surface of the guide plate.

### Example 1

As shown in FIG. 3, tail end 17 of tape 11 is passed through opening 13, under guide plate 25 through gap 27, and through groove 16A in the back of digital device 16. For the small diameter embodiment shown in FIG. 3, tape 12 is pulled through until “setup line” 33 on the outer side of the tape is aligned with setup line 29 on the vernier plate. For an instrument that is sized for a diameter range of 2 inches to 12 inches, the setup line alignment for the initial positioning process is at a three-inch diameter, which is the size of tape loop 35 in FIG. 3.

When alignment is achieved, right button 22 is depressed and held until a line of dashes is displayed in window 23. The tape is then placed around the item to be measured and pulled taught, with five pounds of tension. In window 23 initially appears one of the readings previously identified. Depressing left button 21 serially changes the readings between inches and metric, circumference and diameter. When the desire measurements have been completed, button 22 is again depressed and held until display 23 goes blank.

When not in use, digital device 16 can be programmed to turn off after any desire period of time, typically about five minutes. Actual measurement devices are typically constructed and calibrated in 12 inch increments, for example, 12″ to 24,″ 24″ to 36,″ 36″ to 48,″ 48″ to 60.″ The small diameter device can be 0.75″ to 2,″ or 2″ to 12.″ There are no theoretical size limitations, and examples of practical sizes have been set out here.

### Example 2

The apparatus shown in FIG. 2 operates in the same manner, but it is structured for measuring larger diameter items, which can be of any practical diameter where precision is desired. In this embodiment, vernier plate 15 is much larger and tape 11 is affixed to it by rivets 36 as shown. Set up line 37 on plate 15 is shown, but the location of the setup line on the tape is not shown. However, the FIG. 2 embodiment is set up and used in the same way as the FIG. 3 embodiment. Differences relate primarily to the length of the vernier plate, the length of the tape, and the location of the connection of the tape to the plate.

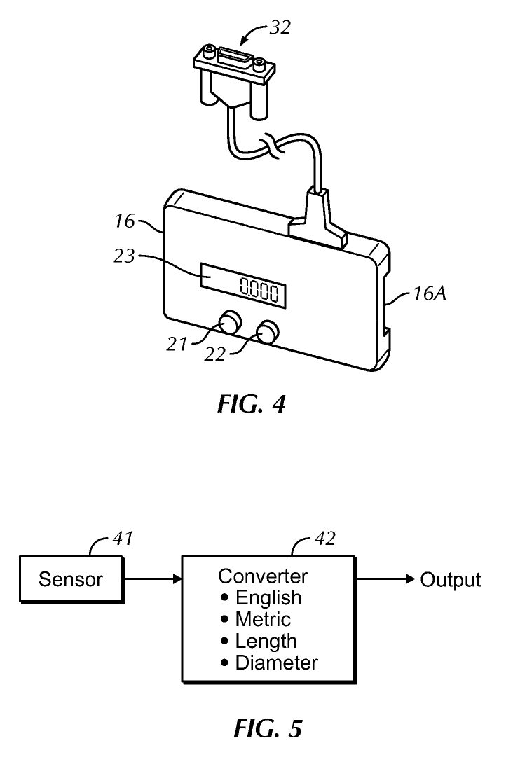

Digital device 16 may be battery powered, or could be externally powered. It may have wireless capability, so that an operator can record the readings on a computer, for example. USB port 32 (FIG. 4) is shown for external connections. Alternatively, a computer or other type of device, such as a smart phone or other electronic device, may be directly connected via connector 32, which an be configured as appropriate for any such external connection. The functions of buttons 21 and 22 could be reversed from the functions described above.

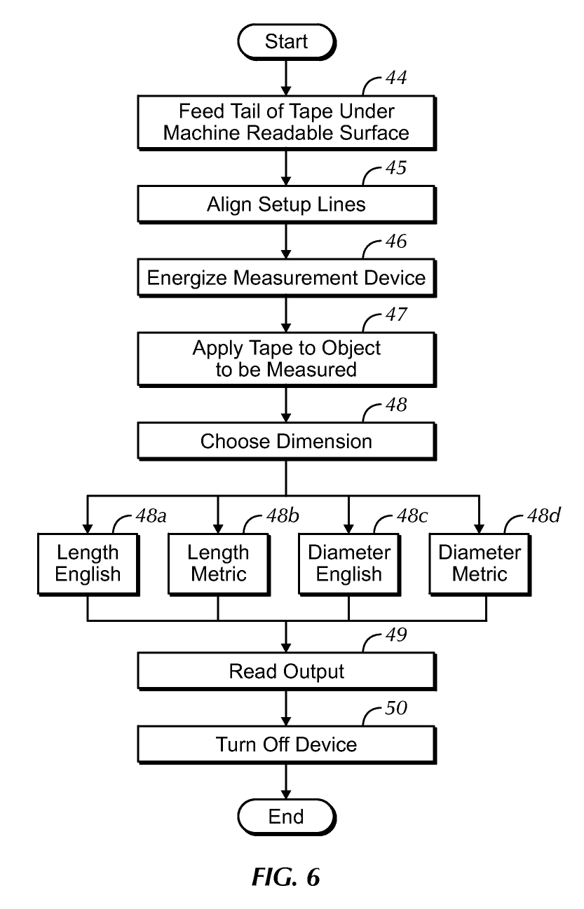

FIG. 6 is a flow chart showing the steps described above. When starting a measurement, the tail end of tape 11 is fed through opening 13 and under the reader element in device 16 as described in step 44. To zero the device, setup lines 29,33 are aligned in step 45. Device 16 is then energized (step 46) by depressing button 22 (if that is the button chosen to turn digital device 16 on and off). The tape in that condition is then applied to the object to be measured in step 47. One of the four readout possibilities 48A, 48B, 48C, 48D is then selected in step 48, the dimension chosen is read in step 49, and the device can then be turned off (50).

It should be noted that the above description relates to using the measurement device to determine external measurements. However, it may also be useful for internal circumference and diameter readings.

What is claimed is:

1. A linear measurement device for determining circumference and diameter measurements of objects, the device comprising:
a tape having a surface with machine readable increments thereon;
a unit coupled to said tape through which said machine readable surface passes;
a reader element in said unit; and
computation means coupled to said reader element to selectively provide digital outputs of diameter and circumference in selected measurement units based on linear positions of said machine readable surface in said unit.

2. The device of claim 1, wherein said computation means comprises of the pi formula for converting linear positions of said machine readable surface to circumference and diameter outputs.

3. The device of claim 1, wherein said unit is positioned adjacent a head end of said tape and said machine readable surface commences a predetermined distance from a tail end of said tape.

4. The device of claim 3, and further comprising a mounting element at said head end of said tape, said unit being secured to said mounting element, said mounting element being formed with an opening through which said tail end of said tape passes to align said machine readable surface thereon with said unit.

5. The device of claim 1, wherein said unit is equipped with battery means for power.

6. The device of claim 1, wherein said unit is equipped to be connected to a source of electrical power.

7. The device of claim 1, wherein said computation means comprises an algorithm programmed with the pi conversion factor and provides said digital outputs.

8. The device of claim 1, wherein said machine readable increments are magnetically readable.

9. The device of claim 1, wherein said machine readable increments are optically readable.

10. The device of claim 4, said mounting element having a first setup line adjacent to said unit, said tape having a second setup line at a predetermined location thereon, said first and second setup lines being aligned in an initial positioning process.

11. The device of claim 4, and further comprising a guide plate on said mounting element intermediate said opening and said unit.

12. The device of claim 4, wherein:
said opening is adjacent a distal end of said mounting element, the distal end of said mounting element is at an angle upward from a top surface of said mounting element, said device further comprising:
a handle on said upwardly angled distal end of said mounting element.

13. The device of claim 4, wherein the tail end of said tape is mounted to said mounting element.

14. The device of claim 4, wherein said tape passes between said mounting element and said reader element in said unit.

15. The device of claim 11, wherein said tape passes between said guide plate and said mounting element, and passes between said mounting element and said reader element in said unit.

16. The device of claim 1, and further comprising means for coupling the outputs of said unit to external devices.

17. A method for determining the circumference and diameter of objects by use of a linear measurement device comprising a tape having a surface with machine readable increments thereon, a unit coupled to said tape through which said machine readable surface passes, a reader element in said unit and computation means coupled to said reader element to selectively provide digital outputs of diameter and circumference in selected measurement units based on linear positions of said machine readable surface in said unit;
initializing the measurement device;
energizing the unit and the computation means;
surrounding an object with the measurement device; and
selecting the readout dimension provided by the measurement device.

18. The method of claim 17, comprising the further step of applying a predetermined tension to the tape after the surrounding step.

19. The method of claim 18, comprising the further step of reading the dimension selected.

20. The method of claim 17, wherein the unit of the measurement device is positioned adjacent a head end of said tape and said machine readable surface commences a predetermined distance from a tail end of said tape and further comprising a mounting element at said head end of said tape, said unit being secured to said mounting element, said mounting element being formed with an opening, the mounting element having a first setup line adjacent to said unit, said tape having a second setup line at a predetermined location thereon, the method further comprising:
inserting the tail end of the tape through the opening;
sliding the tail end of the tape past the machine readable surface; and
aligning the first and second setup line to thereby initialize the unit and the computation means.
